(19) United States
(12) Patent Application Publication
(10) Pub. No.: US 2026/0147008 A1
(43) Pub. Date: May 28, 2026

(54) SYSTEM AND METHOD FOR AUTOMATIC NANOPARTICLE WASHING

(71) Applicant: KOREA INSTITUTE OF SCIENCE AND TECHNOLOGY, Seoul (KR)

(72) Inventors: SangSoo HAN, Seoul (KR); Donghun KIM, Seoul (KR); Heeseung LEE, Seoul (KR)

(73) Assignee: KOREA INSTITUTE OF SCIENCE AND TECHNOLOGY, Seoul (KR)

(21) Appl. No.: 19/264,094

(22) Filed: Jul. 9, 2025

(30) Foreign Application Priority Data
Nov. 25, 2024 (KR) 10-2024-0170078

(51) Int. Cl. G01N 35/00; G01N 35/10; G01N 35/04

(52) U.S. Cl. CPC G01N 35/00732; G01N 35/0099; G01N 35/1002; G01N 2035/00495; G01N 2035/00831; G01N 2035/0405

(57) ABSTRACT

An automating nanoparticles washing method includes transferring a nanoparticle solution contained in each of multiple vials from each of the multiple vials to each of multiple centrifuge tubes, adding a nanoparticle washing solvent to the nanoparticle solution contained in each of the multiple centrifuge tubes for each of the multiple centrifuge tubes, centrifuging the nanoparticle solution including the nanoparticle washing solvent for each of the multiple centrifuge tubes based on a real-time image of a rotor of a centrifuge, and washing nanoparticles contained in the nanoparticle solution for each of the multiple centrifuge tubes by removing the nanoparticle solution from a centrifuged result for each of the multiple centrifuge tubes.

### CROSS-REFERENCE TO RELATED APPLICATION

This application is based on and claims priority under 35 U.S.C. §119 to Korean Patent Application No. 10-2024-0170078, filed on Nov. 25, 2024, in the Korean Intellectual Property Office, the disclosure of which is incorporated by reference herein in its entirety.

### BACKGROUND

### 1. Field

The present disclosure relates to a system and method for automatic nanoparticle washing.

### 2. Description of the Related Art

A nanoparticle washing process is an essential process for removing impurities to obtain reliable data before the properties of a specific material are evaluated, and a method of separating nanoparticles and impurities using a centrifuge is generally used. Because the known nanoparticle washing process is mostly performed manually by operators, the results may change depending on the skill of the operators, and a mistake that damages a sediment layer or incomplete removal of impurities frequently occurs. In particular, the nanoparticle washing process has chronic problems in that fatigues of operators are increased and operation time is inevitably lengthened because operations of injecting washing solvents and removing solutions are repeated.

Recently, attempts to automate chemical experiments have been actively made. However, the attempts are limited to simple repetitive chemical experiments, such as injecting solutions for nanoparticle synthesis or analyzing the characteristics of nanoparticles. The nanoparticle washing process has to be continuously observed by an operator to check whether the process is performed normally, and the nanoparticle washing result changes depending on the operator's careful observation. Due to this, the nanoparticle washing process is still performed manually by an operator.

### SUMMARY

The present disclosure provides a system and method for automating a nanoparticle washing process so as not to cause damage to a sediment layer and incomplete removal of impurities caused by a manual operation of an operator. The present disclosure is not limited to the technical problems described above, and other technical problems may be derived from the following description.

Additional aspects will be set forth in part in the description which follows and, in part, will be apparent from the description, or may be learned by practice of the presented embodiments of the disclosure.

According to an aspect of the present disclosure, an automating nanoparticles washing method includes transferring a nanoparticle solution contained in each of multiple vials from each of the multiple vials to each of multiple centrifuge tubes; adding a nanoparticle washing solvent to the nanoparticle solution contained in each of the multiple centrifuge tubes for each of the multiple centrifuge tubes; centrifuging the nanoparticle solution including the nanoparticle washing solvent for each of the multiple centrifuge tubes based on a real-time image of a rotor of a centrifuge; and washing nanoparticles contained in the nanoparticle solution for each of the multiple centrifuge tubes by removing the nanoparticle solution from a centrifuged result for each of the multiple centrifuge tubes.

The centrifuging of the nanoparticle solution including the nanoparticle washing solvent for each of the multiple centrifuge tubes may include inserting the multiple centrifuge tubes respectively into the multiple holes of the rotor based on a real-time image of the rotor of the centrifuge, and centrifuging the nanoparticle solution including the solvent for each of the multiple centrifuge tubes by driving the centrifuge in a state where the multiple centrifuge tubes are respectively inserted into the multiple holes.

The centrifuging of the nanoparticle solution including the nanoparticle washing solvent for each of the multiple centrifuge tubes may further include extracting the multiple centrifuge tubes respectively from the multiple holes of the rotor based on the real-time image of the rotor of the centrifuge when centrifugation of the centrifuge is completed.

In the inserting of the multiple centrifuge tubes, a current position of each of the multiple holes of the rotor may be detected based on a current position of a color sticker attached to a surface of the rotor of the centrifuge based on the real-time image of the rotor of the centrifuge, and the multiple centrifuge tubes are respectively inserted into the multiple holes of the rotor based on the detected current position of each of the multiple holes.

The surface of the rotor may have a form in which inlets of the multiple hole are arranged radially from a center of a circle, and the color sticker may be attached to a portion corresponding to a circular circumference of the surface of the rotor between two adjacent inlets among the inlets of the multiple holes.

In the inserting of the multiple centrifuge tubes, a current position of each of centers of the inlets of the multiple holes in the surface of the rotor may be detected based on the current position of the color sticker attached to the surface of the rotor of the centrifuge based on the real-time image of the rotor of the centrifuge, and the multiple centrifuge tubes may be respectively inserted into the multiple holes in the surface of the rotor respectively through the inlets of the multiple holes in the surface of the rotor based on the detected current position of the center of each of the inlets of the multiple holes.

The washing of the nanoparticles contained in the nanoparticle solution for each of the multiple centrifuge tubes may include detecting a boundary between the nanoparticle solution and a sediment contained in each of the multiple centrifuge tubes based on the real-time image of each of the multiple centrifuge tubes; and removing the nanoparticle solution from a centrifugation result for each of the multiple centrifugation tubes based on the boundary between the nanoparticle solution and the sediment detected for each of the multiple centrifugation tubes, and the sediment for each of the multiple centrifugation tubes may be nanoparticles contained in the nanoparticle solution for each of the multiple centrifugation tubes.

In the detecting a boundary between the nanoparticle solution and a sediment contained in each of the multiple centrifuge tubes, a process of rotating the multiple centrifugation tubes until the boundary between the nanoparticle solution and the sediment contained in each of the multiple centrifugation tubes is detected and shooting the multiple centrifugation tubes in rotated states may be repeated, and each time the process of rotating the multiple centrifugation tubes is repeated, the multiple centrifugation tubes may be rotated at different angles, and a process of detecting the boundary between the nanoparticle solution and the sediment contained in each of the multiple centrifugation tubes based on the real-time image of each of the multiple centrifugation tubes in the rotated states each time the multiple centrifugation tubes are rotated at different angles may be repeated.

The transferring of the nanoparticle solution to each of the multiple centrifuge tubes may include opening, by a robot arm, lids of the multiple centrifuge tubes; transferring, by an electric pipetting module, the nanoparticle solution contained in each of the multiple vials from each of the multiple vials to each of the multiple centrifuge tubes; and closing, by the robot arm, the lids of the multiple centrifuge tubes.

The adding of the nanoparticle washing solvent may include opening, by the robot arm, the lids of the multiple centrifuge tubes; adding, by the dispenser module, the nanoparticle washing solvent of a preset amount to the nanoparticle solution contained in each of the multiple centrifuge tubes; and closing, by the robot arm, the lids of the multiple centrifuge tubes.

An automatic nanoparticle washing system includes an electric pipetting module configured to transfer a nanoparticle solution contained in each of multiple vials from each of the multiple vials to each of multiple centrifuge tubes; a dispenser module configured to add a nanoparticle washing solvent to the nanoparticle solution contained in each of the multiple centrifuge tubes for each of the multiple centrifuge tubes; a centrifuge configured to centrifuge the nanoparticle solution to which the nanoparticle washing solvent is added for each of the multiple centrifuge tubes; an automatic control module configured to control an operation of the centrifuge to centrifuge the nanoparticle solution to which the nanoparticle washing solvent is added for each of the multiple centrifuge tubes based on a real-time image of a rotor of the centrifuge, wherein the dispenser module washes nanoparticles contained in the nanoparticle solution for each of the multiple centrifuge tubes by removing the nanoparticle solution from a centrifuged result for each of the multiple centrifuge tubes.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a configuration diagram of an automatic nanoparticle washing system according to an embodiment of the present disclosure;

FIG. 2 is an implementation view of the automatic nanoparticle washing system illustrated in FIG. 1;

FIG. 3 is a view illustrating various vial storages and holders used in the automatic nanoparticle washing system illustrated in FIG. 1;

FIG. 4 is a flowchart illustrating an automatic nanoparticle washing method according to an embodiment of the present disclosure;

FIGS. 5 to 9 are views illustrating examples of an electric pipetting module illustrated in FIG. 1;

FIGS. 10 and 11 are enlarged views of a vial storage illustrated in FIG. 3;

FIGS. 12 and 13 are views illustrating examples of a gripper mounted on the end of a robot arm illustrated in FIG. 1;

FIG. 14 is an enlarged view of a centrifuge tube storage illustrated in FIG. 3;

FIG. 15 is a comparative view between a three-dimensional (3D) model and a real photograph of the capping machine illustrated in FIG. 1;

FIGS. 16 and 17 are comparative views between a 3D model and a real photograph of a dispenser module illustrated in FIG. 1;

FIG. 18 is a view of a dispenser actuator illustrated in FIGS. 16 and 17;

FIGS. 19 is a comparative view between a 3D model and a real photograph of the desk actuator;

FIGS. 20 and 21 are views of a centrifuge illustrated in FIG. 1;

FIG. 22 is a view illustrating a process of determining pickup and arrangement of multiple centrifuge tubes in a centrifuge illustrated in FIG. 1;

FIG. 23 is a view illustrating a process of detecting pickup and an arrangement order of respective centrifuge tubes; and

FIGS. 24 and 25 are views illustrating sediments and solution states in respective centrifuge tubes.

### DETAILED DESCRIPTION

Hereinafter, embodiments of the present disclosure are described in detail with reference to the drawings. The embodiments of the present disclosure to be described below relate to a system and method for automating a nanoparticle washing process so as not to cause damage to a sediment layer and impurities to be incompletely removed, which are caused by a manual operation of an operator. Hereinafter, the method and system may be briefly referred to as an "automatic nanoparticle washing method" and an "automatic nanoparticle washing system."

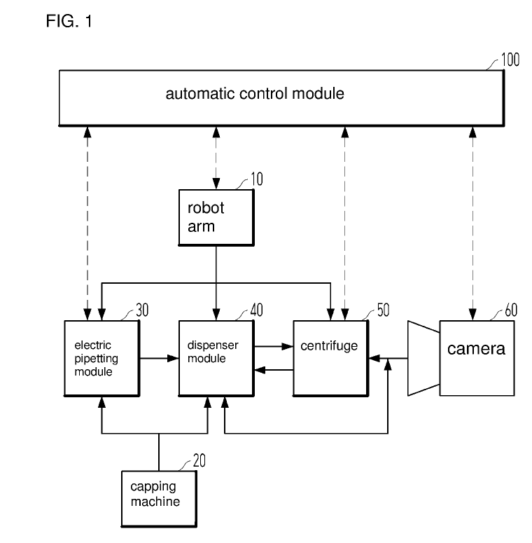

FIG. 1 is a configuration diagram of an automatic nanoparticle washing system according to an embodiment of the present disclosure. Referring to FIG. 1, the automatic nanoparticle washing system according to the present embodiment includes a robot arm 10, a capping machine 20, an electric pipetting module 30, a dispenser module 40, a centrifuge 50, a camera 60, and an automatic control module 100. In order to easily understand the present embodiment while preventing the features of the present embodiment from being obscured, essential components of the present embodiment are illustrated in FIG. 1. Anyone who has ordinary knowledge in the technical field to which the embodiments belong may understand that other configurations may be added to the configuration illustrated in FIG. 1.

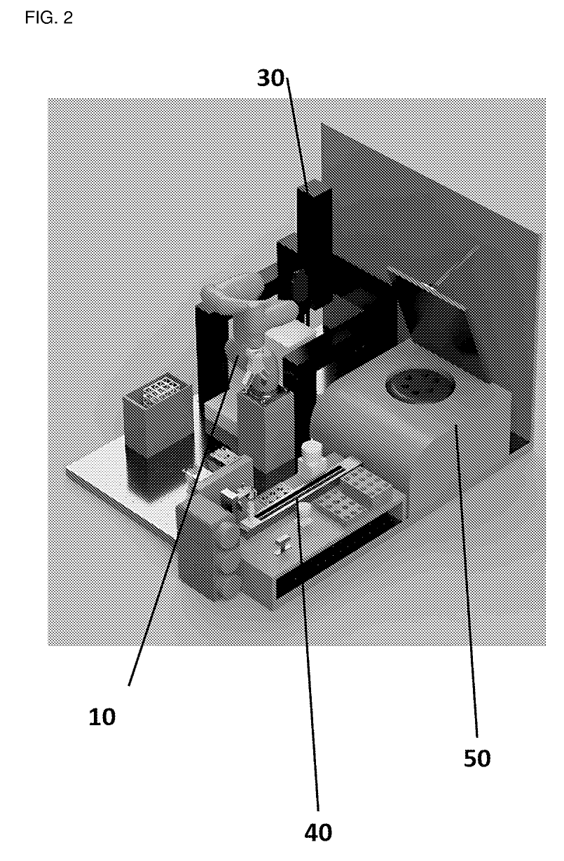

FIG. 2 is an implementation view illustrating the automatic nanoparticle washing system illustrated in FIG. 1. FIG. 2 clearly illustrates an operation region of the robot arm 10 related to the electric pipetting module 30, the dispenser module 40, and the centrifuge 50, and the relationship may increase operation efficiency and accuracy. The electric pipetting module 30 and the dispenser module 40 are placed on the same plane to reduce a physical interference between operations, and the centrifuge 50 is placed at a position designed to efficiently process a result after a washing operation.

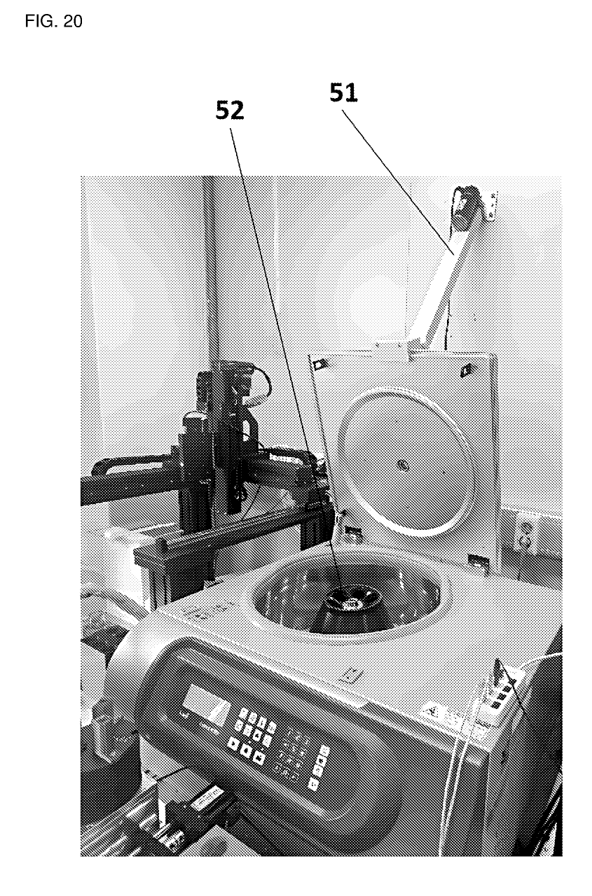

The camera 60 is attached to the robot arm 10 and moves together with the robot arm 10 to shoot the inside of a centrifuge tube in real time. The internal images taken in real time by the camera 60 are used to control operations of the centrifuge 50 and the dispenser module 40. The camera 60 shoots a rotor 52 (in FIG. 20) and a centrifuge tube in real time to check whether the centrifuge tube is accurately placed on the rotor 52 of the centrifuge 50 under the control by the automatic control module 100. The automatic control module 100 monitors positions and distributions of a solution and a sediment inside the centrifuge tube, and when a state in which the sediment is biased to one side in the centrifuge tube is detected, the automatic control module 100 adjusts a rotation speed of the centrifuge 50 such that the sediment is uniformly separated. The automatic control module 100 detects a boundary layer between the solution and the sediment in real time and controls an operation of the dispenser module 40 based on the detected boundary position. This process prevents the solution and the sediment from being mixed together and supports accurate solution removal.

A vial stores and preserves a nanoparticle solution and is used before the solution is transferred to the centrifuge tube by the electric pipetting module 30. The vial is moved by the robot arm 10, and a lid of the vial is opened and closed by the capping machine 20. Also, multiple vials are stored in a vial storage 71. The centrifuge tube is a vial that stores or transfers a nanoparticle solution during an operation, and is generally called a "falcon tube ". The centrifuge tube is used in the centrifuge 50 to separate a sediment from a solution. The centrifuge tube is transferred to the dispenser module 40 and the centrifuge 50 by the robot arm 10, and when a nanoparticle washing operation is completed, the centrifuge tube is stored back in the centrifuge tube storage 72.

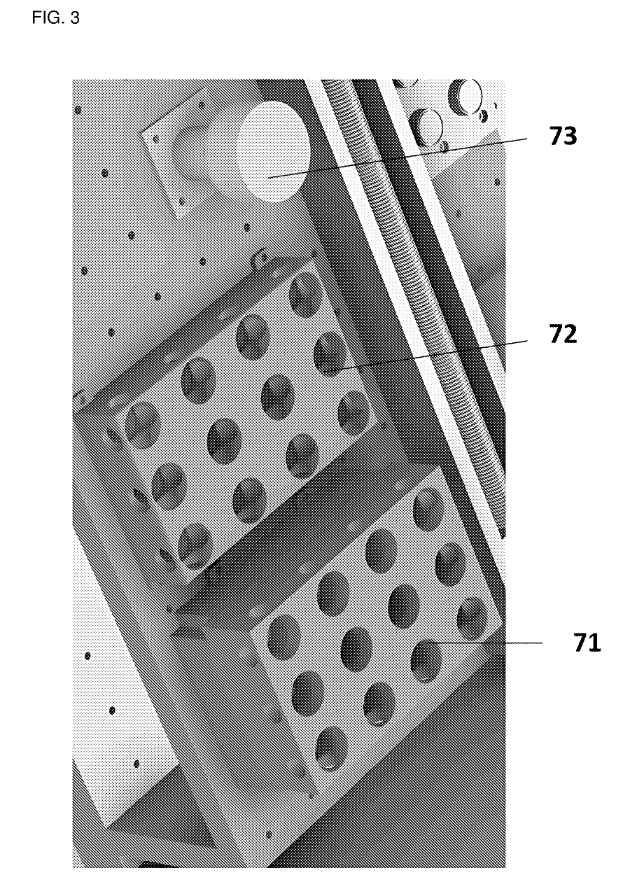

FIG. 3 is a view illustrating various vial storages and holders used in the automatic nanoparticle washing system illustrated in FIG. 1. Referring to FIG. 3, a vial storage 71 is a case for storing multiple vials and stores the multiple vials in an organized state such that the robot arm 10 may easily access the multiple vials. A centrifuge tube storage 72 is a case for safely storing multiple centrifuge tubes before and after an operation and allows the robot arm 10 to arrange the centrifuge tubes in an accurate positions after an operation. An alignment holder 73 fixes positions of the centrifuge tubes such that the robot arm 10 may stably pick up the centrifuge tubes at the same position.

The automatic control module 100 controls operations of the robot arm 10, the capping machine 20, the electric pipetting module 30, the dispenser module 40, and the centrifuge 50 such that a nanoparticle solution contained in each of the multiple vials may be automatically washed based on real-time images taken by the camera 60.

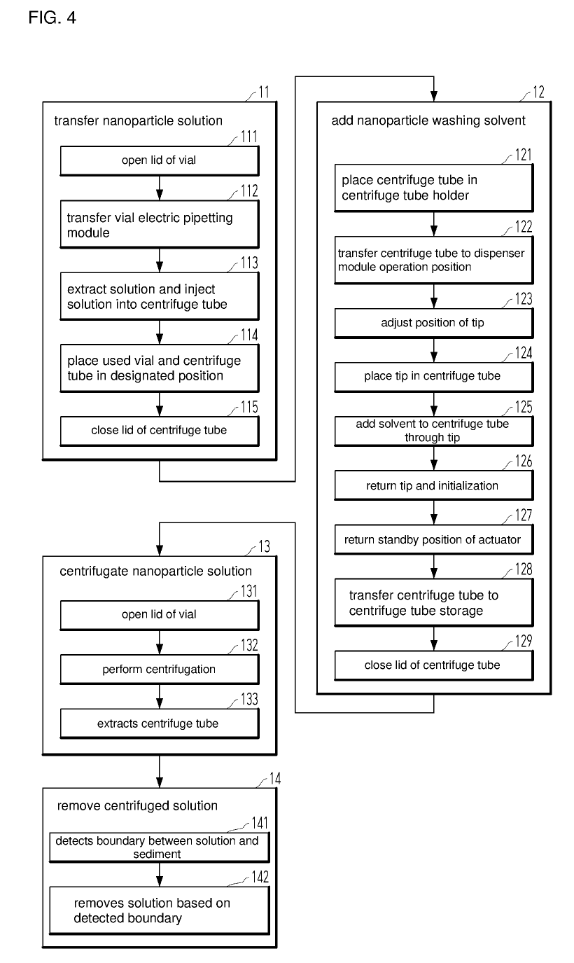

FIG. 4 is a flowchart illustrating an automatic nanoparticle washing method according to an embodiment of the present disclosure. Referring to FIG. 4, the automatic nanoparticle washing method according to the present embodiment includes following operations performed by the nanoparticle washing system illustrated in FIG. 1. Hereinafter, the automatic nanoparticle washing system illustrated in FIG. 1 and the automatic nanoparticle washing method illustrated in FIG. 4 are described in detail with reference to FIGS. 1 and 4.

In operation 11, the electric pipetting module 30 transfers nanoparticle solutions contained in multiple vials to multiple centrifuge tubes from the multiple vials under the control by the automatic control module 100. The electric pipetting module 30 extracts a preset amount of the nanoparticle solution from the multiple vials by a user under the control by the automatic control module 100 and injects the extracted nanoparticle solution into each of the multiple centrifuge tubes.

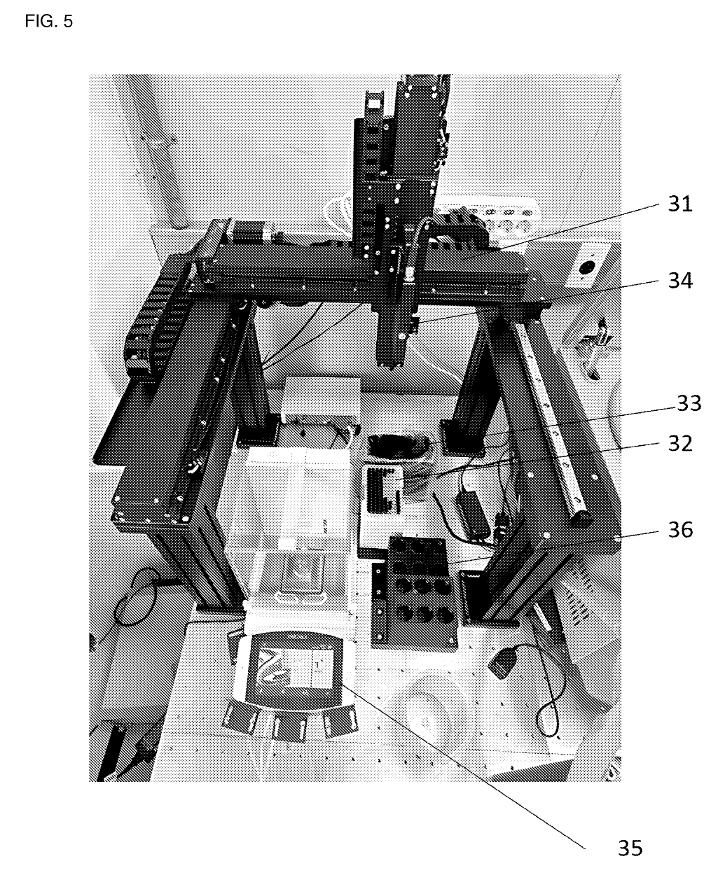

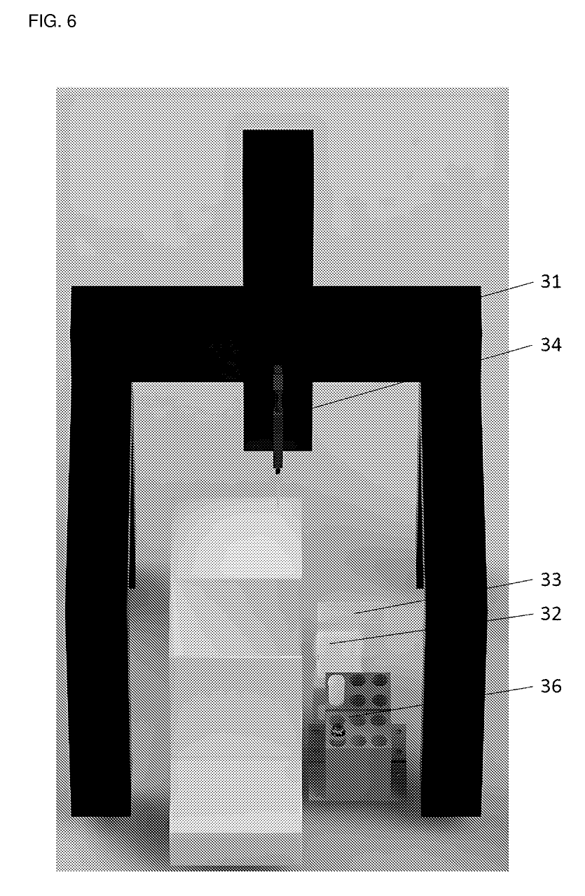

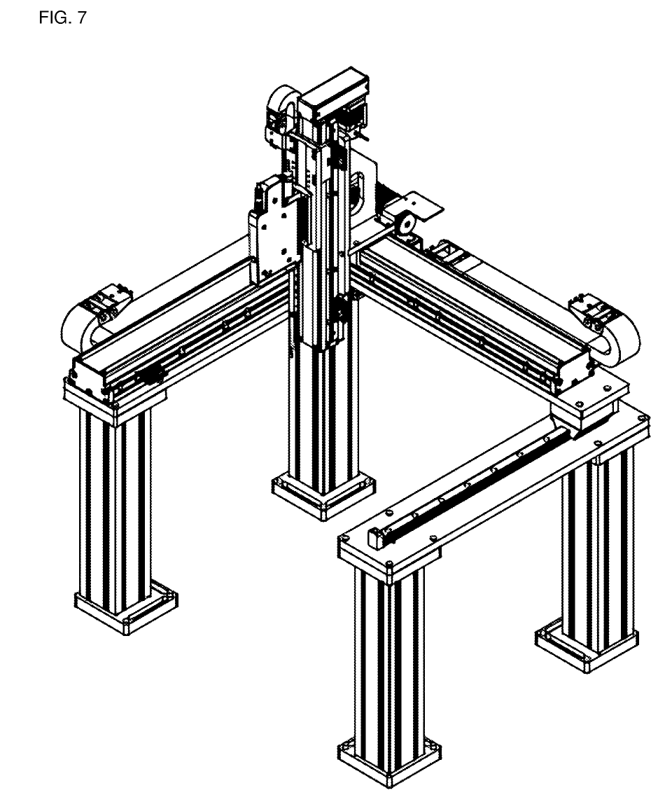

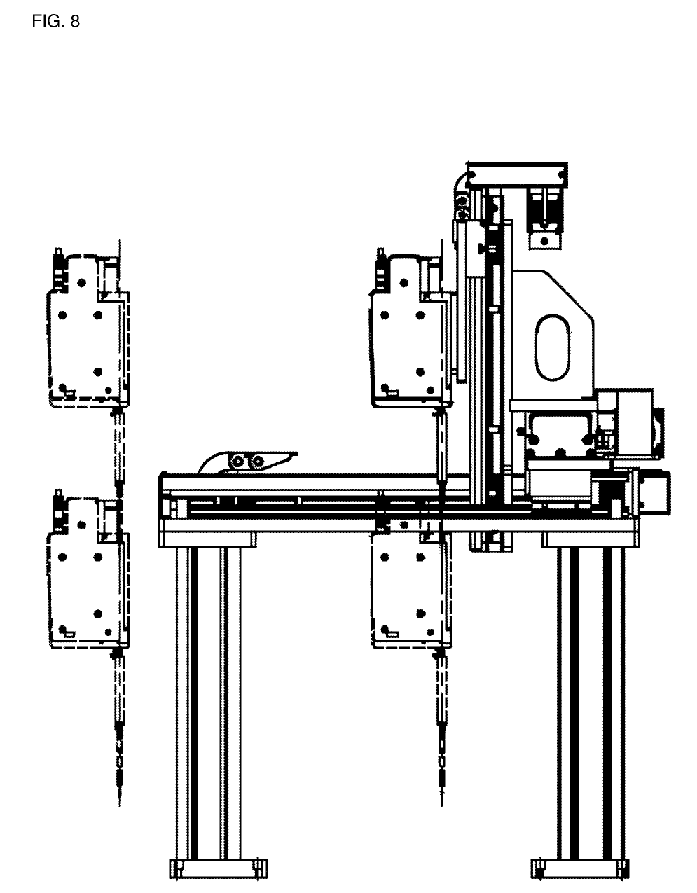

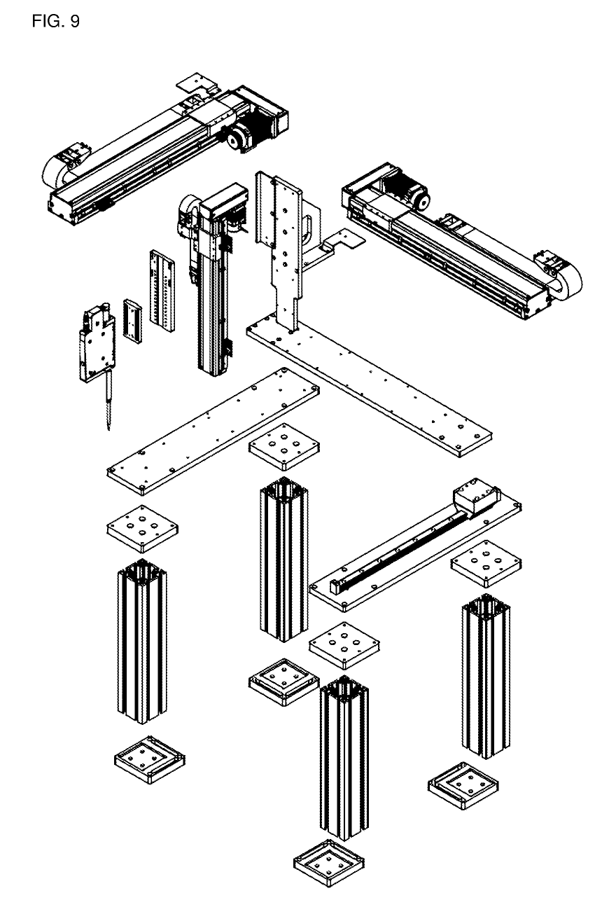

FIGS. 5 to 9 are views illustrating examples of the electric pipetting module 30 illustrated in FIG. 1. FIG. 5 is an actual photograph of the electric pipetting module 30 taken in an actual operation environment, and FIG. 6 illustrates a three-dimensional model of the electric pipetting module 30. FIG. 7 is a perspective view of the electric pipetting module 30, FIG. 8 is a front view of the electric pipetting module 30, and FIG. 9 is an exploded view of the electric pipetting module 30. Referring to FIGS. 5 to 9, the electric pipetting module 30 is a device that transfers a nanoparticle solution stored in a vial to a centrifuge tube and includes an actuator 31, a tip rack 32, a tip waste bin 33, an electronic pipette 34, a weight measurement device 35, and a centrifuge tube holder 36.

The electric pipetting module 30 moves precisely along the X, Y, and Z axes, and performs a pipetting operation by precisely adjusting a position between a vial and a centrifuge tube. The electric pipetting module 30 performs a process of extracting the nanoparticle solution contained in each vial according to the amount of solution input by a user and then accurately injecting the nanoparticle solution into a centrifuge tube, and performs the pipetting operation repeatedly. For example, the electronic pipette 34 may extract a solution of maximum 1 ml in one operation, and repeatedly performs the same operation three times to transfer a solution of 3 ml. The electric pipetting module 30 is designed to be able to install a new electronic pipette tip in the tip rack 32 and to discard the used electronic pipette tip into the tip waste bin 33 after the operation. The automatic control module 100 controls an operation sequence of the electric pipetting module 30 and precisely controls a tip replacement and solution transfer process.

The actuator 31 moves precisely along the X, Y, and Z axes and performs an operation of extracting or transferring a nanoparticle solution through the electronic pipette 34. The actuator 31 is coupled to the electronic pipette 34 to perform an operation of extracting a nanoparticle solution from the vial and then accurately injecting the nanoparticle solution into the centrifuge tube. The tip rack 32 stores and manages the electronic pipette tip used in the electric pipetting module 30. After the actuator 31 extracts the nanoparticle solution from the vial using the electronic pipette tip, and when the operation is completed, the used tip is discarded in the tip waste bin 33, and a new tip is mounted on the tip rack 32. The tip waste bin 33 discards the pipette tip used in the electric pipetting module 30.

The electronic pipette 34 is a device that precisely extracts and transfers a nanoparticle solution in the vial or centrifuge tube. The electronic pipette 34 performs an operation of extracting an accurate amount of solution by mounting a pipette tip and moving the solution to the centrifuge tube to inject the solution into the centrifuge tube. The weight measurement device 35 is used to measure a weight of the centrifuge tube or vial to check the amount of nanoparticle solution or washing solvent contained therein. The centrifuge tube holder 36 stably fixes the centrifuge tube during an operation and aligns and stores the centrifuge tube before and after the centrifuge tube is transferred to an operation position. The centrifuge tube holder 36 is linked to the camera 60 to shoot a state and a position of the centrifuge tube in real time.

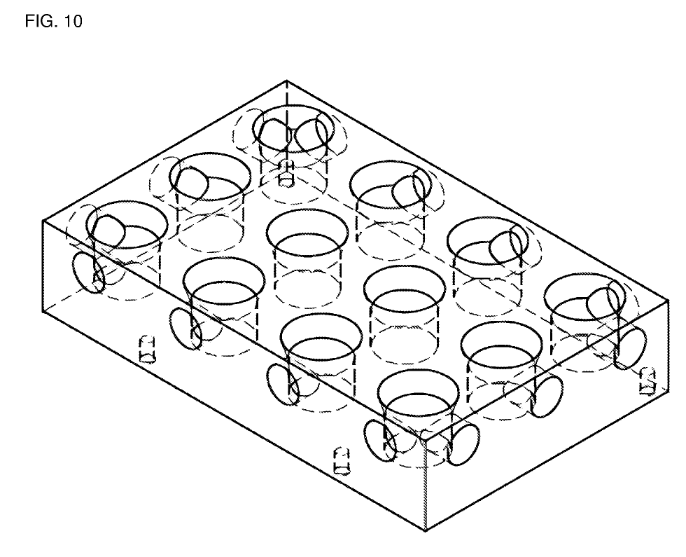

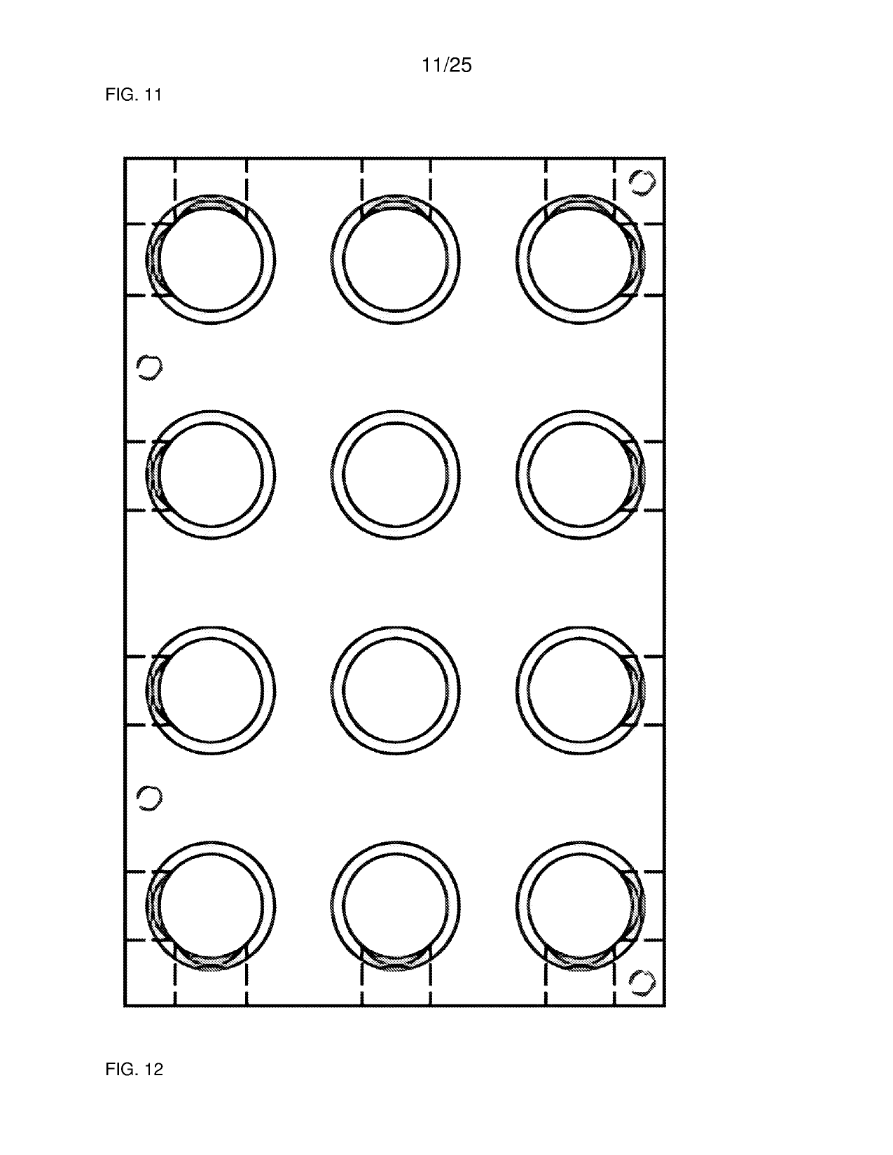

In operation 111, the robot arm 10 opens lids of multiple centrifuge tubes arranged in the centrifuge tube storage 72 under the control by the automatic control module 100. The robot arm 10 may open the lids of the multiple centrifuge tubes using the capping machine 20. The nanoparticle solution in which nanoparticles are mixed with impurities is contained in multiple vials arranged in the vial storage 71. FIGS. 10 and 11 are enlarged views of the vial storage 71 illustrated in FIG. 3. FIG. 10 is a perspective view illustrating the vial storage 71, and FIG. 11 is a plan view illustrating the vial storage 71. Referring to FIG. 10, the vial storage 71 has a rectangular solid shape, and multiple circular holes are arranged regularly. The centrifuge tube storage 72 has a shape similar to a shape of the vial storage 71.

In operation 112, the robot arm 10 transfers multiple centrifuge tubes with open lids and multiple vials containing nanoparticle solutions from the vial storage 71 and the centrifuge tube storage 72 to the electric pipetting module 30 under the control by the automatic control module 100. The robot arm 10 has a multi-axis joint structure and may move at various positions and angles within an operation range. a forceps-type gripper 11 and an electric vacuum gripper 12 may be selectively mounted on the end of the robot arm 10 via a tool changer. The robot arm 10 is linked with the electric pipetting module 30 to transfer the nanoparticle solution between the vial and the centrifuge tube.

For example, the robot arm 10 picks up a vial containing the nanoparticle solution using the forceps-type gripper 11 and moves the vial to an operation position of the electric pipetting module 30 to transfer the nanoparticle solution to the centrifuge tube. Thereafter, the robot arm 10 picks up the centrifuge tube using the electric vacuum gripper 12 and places the centrifuge tube on a rotor of the centrifuge 50. The robot arm 10 retrieves the centrifuge tube, for which a centrifugation operation is completed, from the centrifuge 50 using the electric vacuum gripper 12 and moves the centrifuge tube to the dispenser module 40.

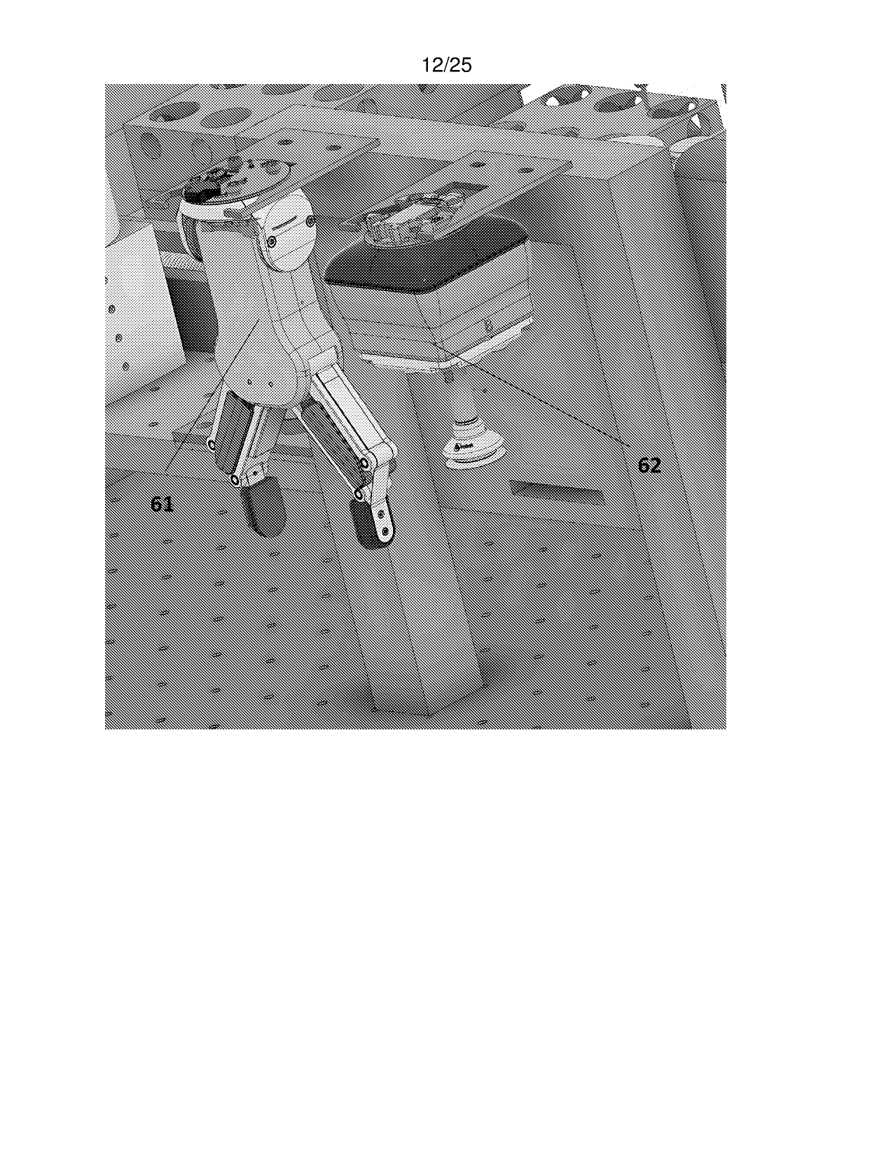

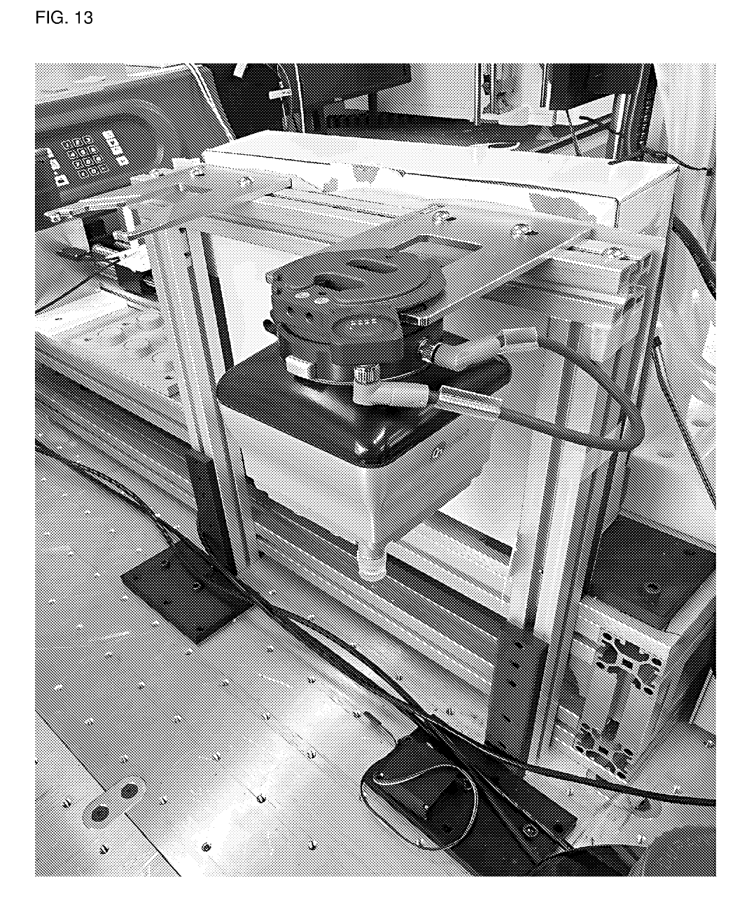

FIGS. 12 and 13 are views illustrating examples of a gripper mounted on the end of the robot arm 10 illustrated in FIG. 1. Referring to FIGS. 12 and 13, the forceps-type gripper 11 has a two-long-forceps-shaped structure and may stably hold a chemical vial or equipment. The forceps have fine saw-shaped surfaces to stably fix an object, and opening and closing angles of the forceps may be adjusted to handle vials of various sizes. The electric vacuum gripper 12 has a structure in which multiple circular suction pads are arranged at lower portions of square bodies. The multiple circular suction pads stably hold an object, such as a smooth surface or the centrifuge tube of a specific shape through vacuum suction.

In operation 113, the electric pipetting module 30 transfers the nanoparticle solution, which is contained in each of the multiple vials in operation 112, from each of the multiple vials to each of the multiple centrifuge tubes under the control by the automatic control module 100. The electric pipetting module 30 extracts the nanoparticle solution from each of the multiple vials in conjunction with the electronic pipette 34, and then moves and injects the nanoparticle solution into each of the multiple centrifuge tubes. In this process, the electric pipetting module 30 moves precisely in the X, Y, and Z axes, and accurately adjusts a position between the vial and the centrifuge tube. The electronic pipette 34 extracts the nanoparticle solution by the amount set by a user, and when the operation is completed, the electronic pipette 34 automatically discards the used pipette tip and mounts a new tip.

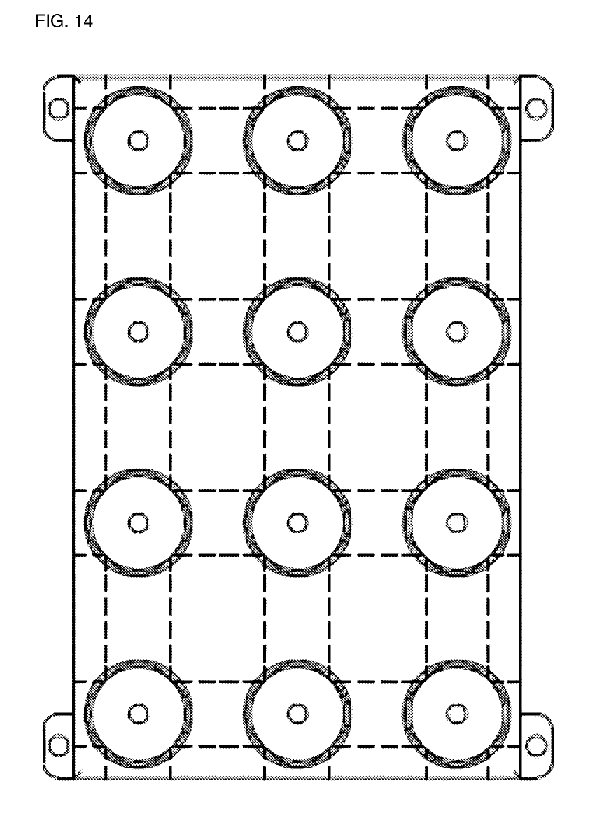

In operation 114, the robot arm 10 transfers multiple vials from the electric pipetting module 30 to the vial storage 71 and transfers multiple centrifuge tubes to the centrifuge tube storage 72 under the control by the automatic control module 100. The centrifuge tube storage 72 stores the multiple centrifuge tubes, and enables the multiple centrifuge tubes to be aligned to a set position and safely stored. The centrifuge tube storage 72 is designed to maintain a position of the centrifuge tubes such that the robot arm 10 may take out and use the multiple centrifuge tubes when necessary during an operation. FIG. 14 is an enlarged view of the centrifuge tube storage 72 illustrated in FIG. 3. Referring to FIG. 14, the centrifuge tube storage 72 is designed to have a flat structure in which multiple circular holes are arranged, and each of the multiple circular holes is formed to stably fix each of the multiple centrifuge tubes. A support structure for internal fixation is formed around the circular hole to prevent the centrifuge tube from shaking or falling off.

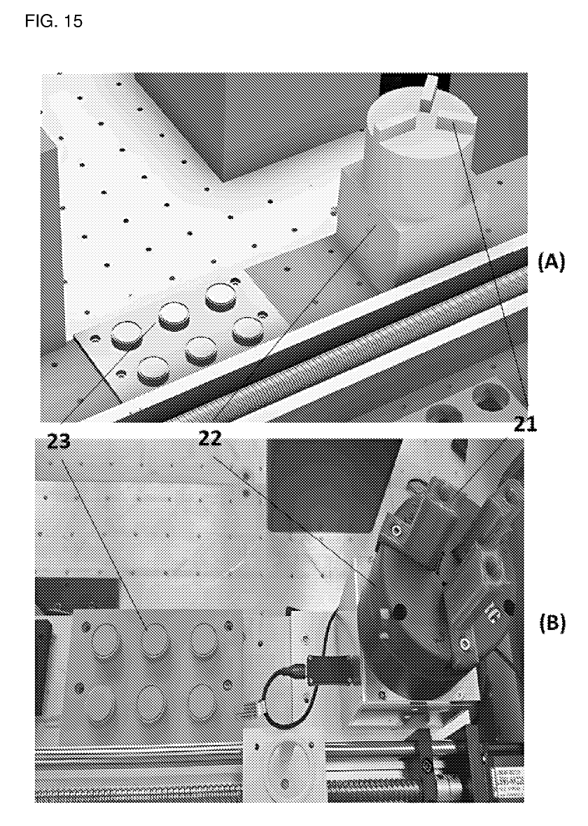

In operation 115, the robot arm 10 closes lids of the multiple centrifuge tubes, which are transferred to the centrifuge tube storage 72 in operation 114, under the control by the automatic control module 100. The robot arm 10 may safely close the lids of the multiple centrifuge tubes using the capping machine 20. FIG. 15 is a comparative view between a three-dimensional (3D) model and a real photograph of the capping machine 20 illustrated in FIG. 1. (A) of FIG. 15 is a 3D model of the capping machine 20, and (B) of FIG. 15 is a real photograph of the capping machine 20. Referring to FIG. 15, the capping machine 20 is a device that automatically opens and closes the lids of the multiple centrifuge tubes or other chemical vials, and includes a capping finger 21, a rotation unit 22, and a cap holder 23. The respective components of the capping machine 20 fix, rotate, and store the lids.

The capping finger 21 holds the lid of the centrifuge tube or vial. The capping finger 21 is connected to the rotation unit 22 and opens or closes the lid by rotating clockwise or counterclockwise according to an operation of the rotation unit 22. The capping finger 21 stably fixes the lid during a capping operation, thereby protecting contents of the centrifuge tube or vial from leaking out. The rotation unit 22 is connected to the capping finger 21 and rotates clockwise or counterclockwise to open or close the lid of the centrifuge tube or vial. The rotation unit 22 performs an operation of releasing or tightening the lid through an accurate rotational motion while the cap finger 21 stably fixes the lid. The cap holder 23 temporarily stores the lid removed from the centrifuge tube or vial.

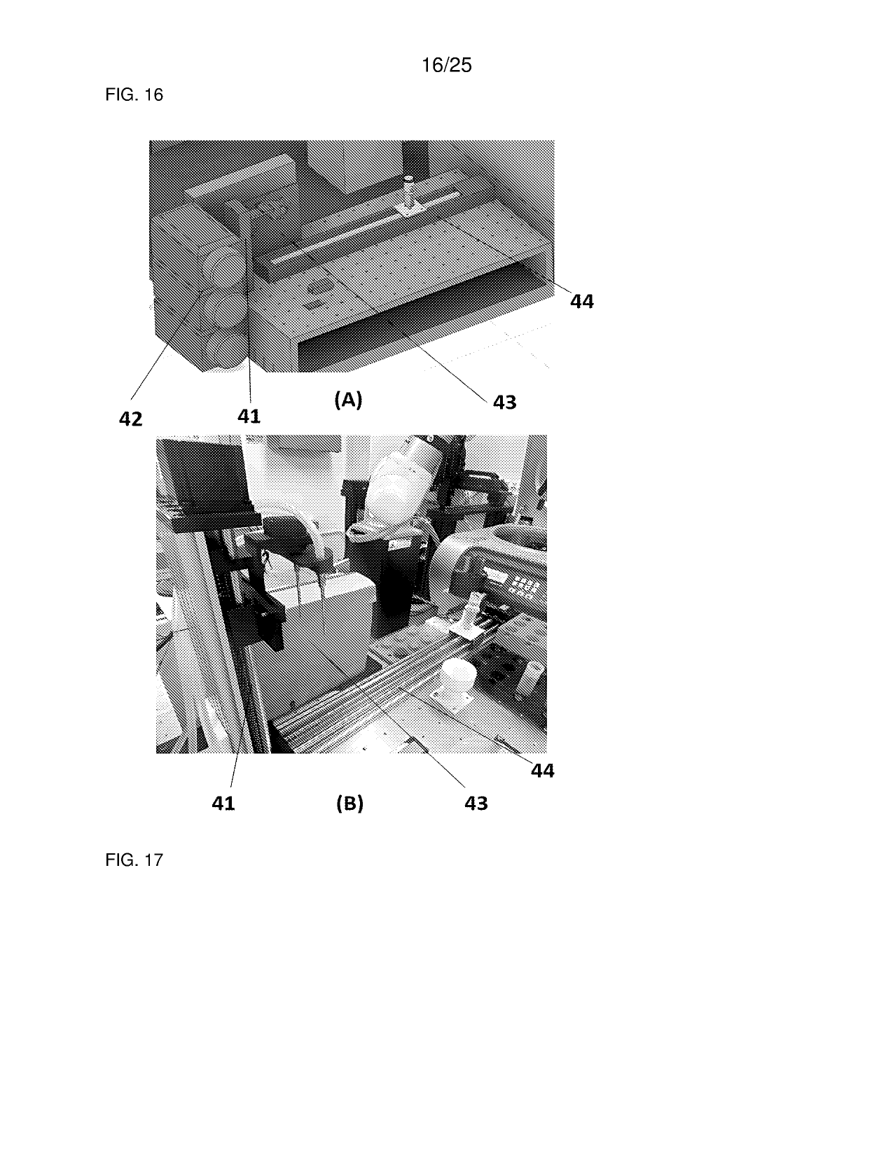

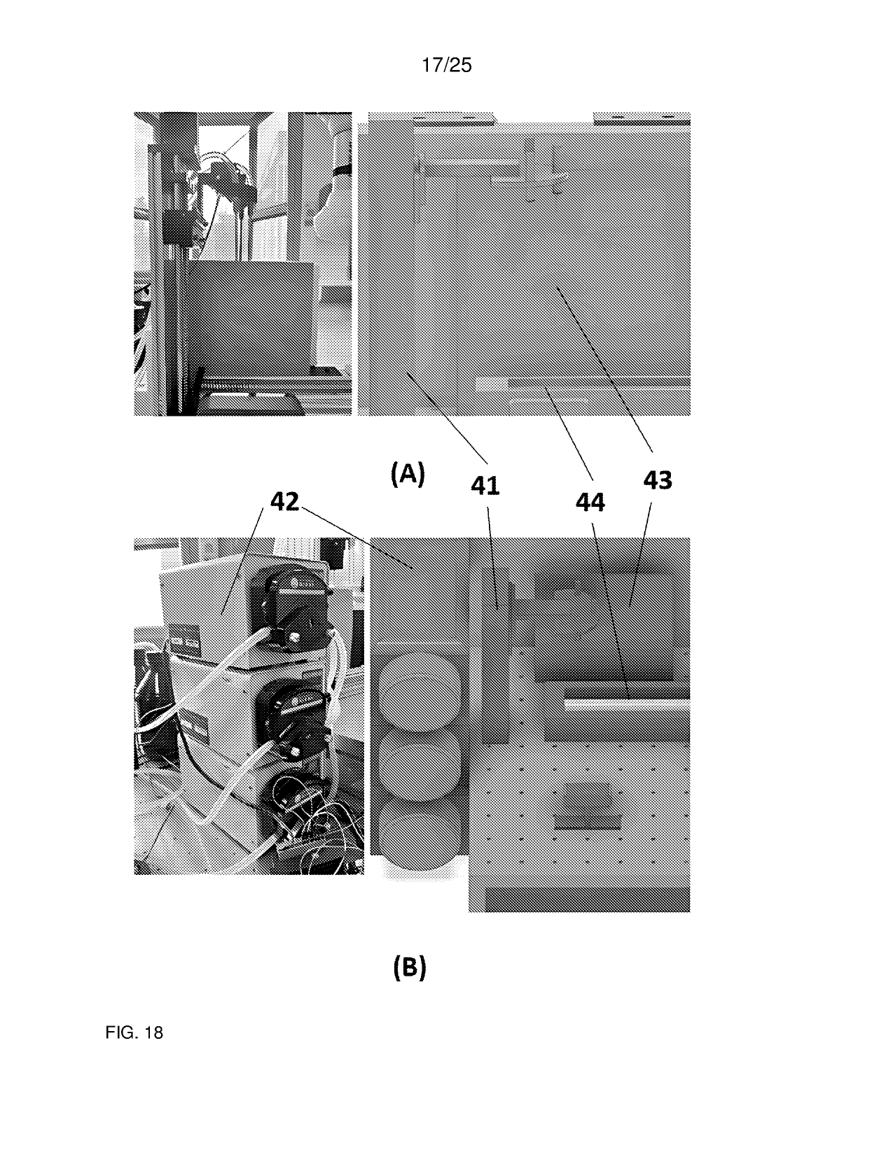

In operation 12, the dispenser module 40 adds a nanoparticle washing solvent for each centrifuge tube to the nanoparticle solution contained in the centrifuge tube according to the control of the automatic control module 100. The dispenser module 40 precisely injects the solvent set by a user using a servo motor and a pump 42, and the amount of injected solvent is adjusted according to a value previously set by the user. The dispenser module 40 adds a nanoparticle washing solvent to the nanoparticle solution contained in the centrifuge tube or removes the solution from the centrifuged result to wash the nanoparticles contained in the nanoparticle solution. FIGS. 16 and 17 are comparative views between a 3D model and a real photograph of the dispenser module 40 illustrated in FIG. 1. Referring to FIGS. 16 and 17, the dispenser module 40 includes a dispenser actuator 41, the pump 42, a computer vision background board 43, and a desk actuator 44.

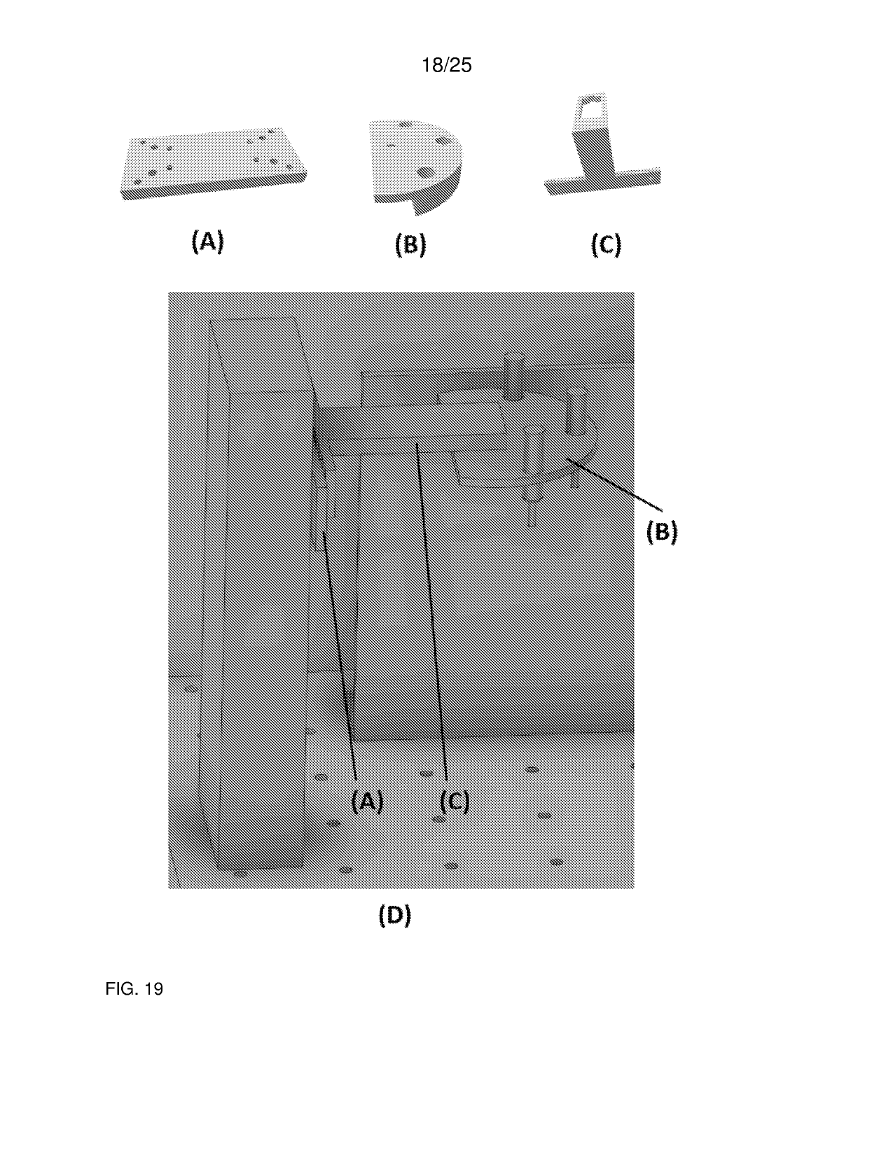

The dispenser actuator 41 performs a function of placing the centrifuge tube in the dispenser module 40 or returning the centrifuge tube to a designated position after an operation. The dispenser actuator 41 is connected to a servo motor and precisely controls a position of the centrifuge tube to help a solvent injection operation to be performed smoothly. FIG. 18 is a view illustrating the dispenser actuator 41. (A) of FIG. 18 illustrates a structure for fixing an actuator and a servo motor, and (B) of FIG. 18 illustrates a tip dispenser that fixes a removal tip and performs a rotational motion. (C) of FIG. 18 illustrates a bracket for fixing the servo motor, and fixes a position such that the servo motor may operate accurately. (D) of FIG. 18 is a coupling view of (A), (B), and (C).

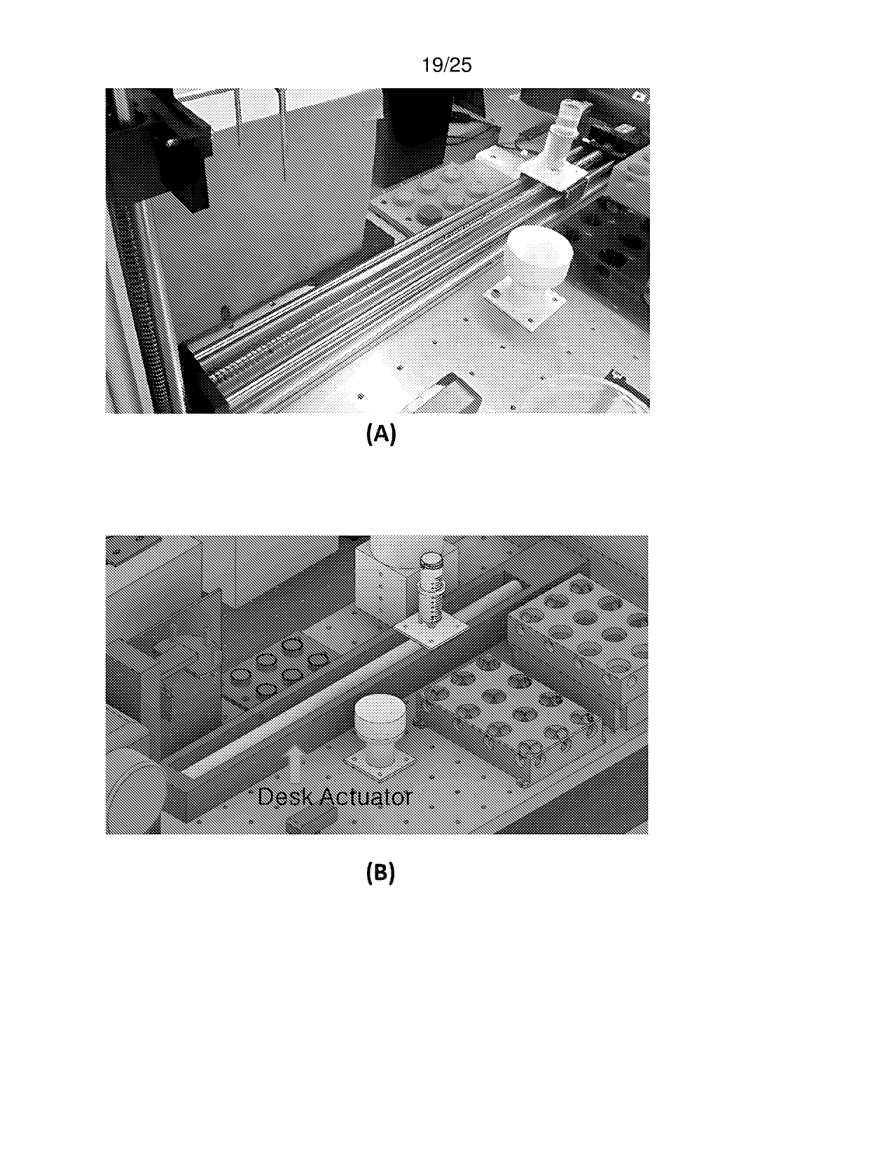

The computer vision background board 43 is used as a background when the camera 60, which observes a state of the centrifuge tube, operates. The computer vision background board 43 is a structure set so as not to be affected by light and a background during an operation, and helps the camera 60 to clearly observe state of a sediment and a solution in the centrifuge tube. FIG. 19 is a comparative view between a 3D model and a real photograph of the desk actuator 44. Referring to FIG. 19, the desk actuator 44 performs a function of transferring a centrifuge tube from a position in which the robot arm 10 does not reach. The desk actuator 44 accurately places the centrifuge tube in a designated position such that a solvent injection or a solution removal operation is performed smoothly.

In operation 121, the robot arm 10 transfers and places multiple centrifuge tubes from the centrifuge tube storage 72 to the centrifuge tube holder of the dispenser module 40 under the control by the automatic control module 100, and opens lids of multiple centrifuge tubes. The robot arm 10 picks up a centrifuge tube from the centrifuge tube storage 72 and moves the centrifuge tube to the centrifuge tube holder placed above the dispenser actuator 41.

In operation 122, the dispenser module 40 places multiple centrifuge tubes, which are placed in the centrifuge tube holder in operation 121, at a solvent injection position of the dispenser module 40 using the dispenser actuator 41 under the control by the automatic control module 100. In operation 123, the dispenser module 40 rotates the tip of the dispenser module 40 to face the centrifuge tube, which is transferred in operation 122, under the control by the automatic control module 100. The dispenser module 40 consists of a total of three tips, one of which is used to remove a solution, and two tips of which are used to inject the solvent.

In operation 124, the dispenser module 40 places the tip, which is rotated in operation 123, in the centrifuge tube using the dispenser actuator 41 under the control by the automatic control module 100. In this process, the dispenser actuator 41 may move the tip such that a distal end of the rotated tip is precisely aligned with an opening of the centrifuge tube through precise control of the servo motor. While the tip is inserted into the centrifuge tube, the dispenser actuator 41 may precisely adjust a position and angle of the tip such that an insertion depth of the tip reaches a set reference value.

In operation 125, the dispenser module 40 adds a nanoparticle washing solvent of an amount previously set by a user to the nanoparticle solution contained in each centrifuge tube under the control by the automatic control module 100. The dispenser module 40 may inject a solvent into the centrifuge tube using the pump 42 connected to the tip, which is placed inside the centrifuge tube in operation 124. The pump 42 performs an operation of sucking or discharging the solution in the centrifuge tube, and is designed to be able to control an exact amount during an injection and removal process. The pump 42 operates with the rotation of the servo motor to precisely control the flow of a solution.

In operation 126, the dispenser module 40 returns the dispenser actuator 41 to an original position under the control by the automatic control module 100, and at the same time, rotates the servo motor to return the tip to an initial position. The dispenser actuator 41 returns to an initial position under the precise control by the servo motor along a trajectory moved during the previous operation, and at the same time, the servo motor adjusts a direction and position of the tip mounted on the dispenser module 40 to return the tip rotated during the operation to the initial position.

In operation 127, the dispenser module 40 completely returns the dispenser actuator 41 to the initial operation position under the control by the automatic control module 100. In this process, the dispenser actuator 41 returns along a reverse order of a path moved during the operation under the control by the servo motor. The return process initializes an internal state of the dispenser module 40 to prepare for a next operation to be performed smoothly.

In operation 128, the robot arm 10 transfers the centrifuge tube from the dispenser module 40 to the centrifuge tube holder 36 by the dispenser actuator 41 under the control by the automatic control module 100. The robot arm 10 moves to an operation region of the dispenser module 40 using a multi-axis joint structure, and catches the centrifuge tube in a state of being adjusted to facilitate handling of the centrifuge tube by the dispenser actuator 41. After picking up the centrifuge tube, the robot arm 10 moves to the centrifuge tube holder 36 while maintaining a balance and alignment of the centrifuge tube. In this process, the robot arm 10 moves along a pre-set trajectory and speed, and maintains stability such that contents are not damaged by an external impact or vibration while transferring the centrifuge tube. When the centrifuge tube reaches a position of the centrifuge tube holder 36, the robot arm 10 accurately places the centrifuge tube in the center of the holder and checks that the centrifuge tube is stably fixed.

In operation 129, the robot arm 10 closes a lid of the centrifuge tube placed in the centrifuge tube holder 36 using the capping machine 20 under the control by the automatic control module 100. The robot arm 10 searches for a central axis of the centrifuge tube placed in the centrifuge tube holder 36 through a multi-axis joint structure and adjusts the position to be aligned with the capping machine 20. In this process, the robot arm 10 makes a position of the centrifuge tube precisely consistent with a position of the capping machine 20 based on the input coordinate data. Thereafter, the capping finger 21 included in the capping machine 20 stably holds the lid of the centrifuge tube to perform a rotational motion in synchronization with the rotation unit 22, and causes the lid to come into close contact with an inlet of the centrifuge tube. The rotation unit 22 rotates the lid clockwise.

In operation 13, the centrifuge 50 centrifuges the nanoparticle solution, to which a solvent is added in operation 12, for each centrifuge tube based on real-time images of the rotor 52 of the centrifuge 50 under the control by the automatic control module 100. The automatic control module 100 controls an operation of the centrifuge such that the nanoparticle solution, to which a solvent is added in each centrifuge tube, is centrifuged based on the real-time images of the rotor 52 of the centrifuge 50. The centrifuge 50 separates the solvent and the nanoparticles by centrifuging the nanoparticle solution contained in the centrifuge tube. The rotor 52 of the centrifuge 50 rotates at a high speed such that the nanoparticles inside the solution are precipitated or separated by centrifugal force. The centrifuge 50 places the centrifuge tube in an accurate position through an actuator 51, and controls a speed and rotation time using an Arduino and a relay module.

The centrifuge 50 is composed of the actuator 51, the rotor 52, an Arduino, a relay module, and a motor driver. The actuator 51 accurately places the centrifuge tube in a designated slot inside the rotor 52, and moves the centrifuge tube back to the original position after the operation is completed. The actuator 51 also performs a function of opening and closing a door of the centrifuge 50, and ensures the safe movement of a centrifuge tube. The rotor 52 fixes the centrifuge tube inside the centrifuge 50 and then rotates the centrifuge at a high speed to separate nanoparticles from a solvent. The rotor 52 effectively separates particles in a solution by centrifugal force, and may rotate multiple centrifuge tubes at the same time.

Arduino controls a speed, rotation direction, and operation time of the centrifuge 50 under the control by the automatic control module 100. The Arduino monitors and adjusts the entire operation state of the centrifuge 50 in real time in conjunction with the actuator 51 and a relay module under the control by the automatic control module 100. The relay module is connected to the Arduino and controls the power of the centrifuge 50. A three-dimensional (3D) printer joint performs a function of manufacturing or replacing components required for a centrifugation operation using 3D printing. A motor driver is connected to the Arduino and controls a motor of the centrifuge 50 under the control by the automatic control module 100. The motor driver controls the motor's operation parameters, such as a rotation speed, a direction, and acceleration of the centrifuge 50, and performs an operation in response to a signal received from the Arduino.

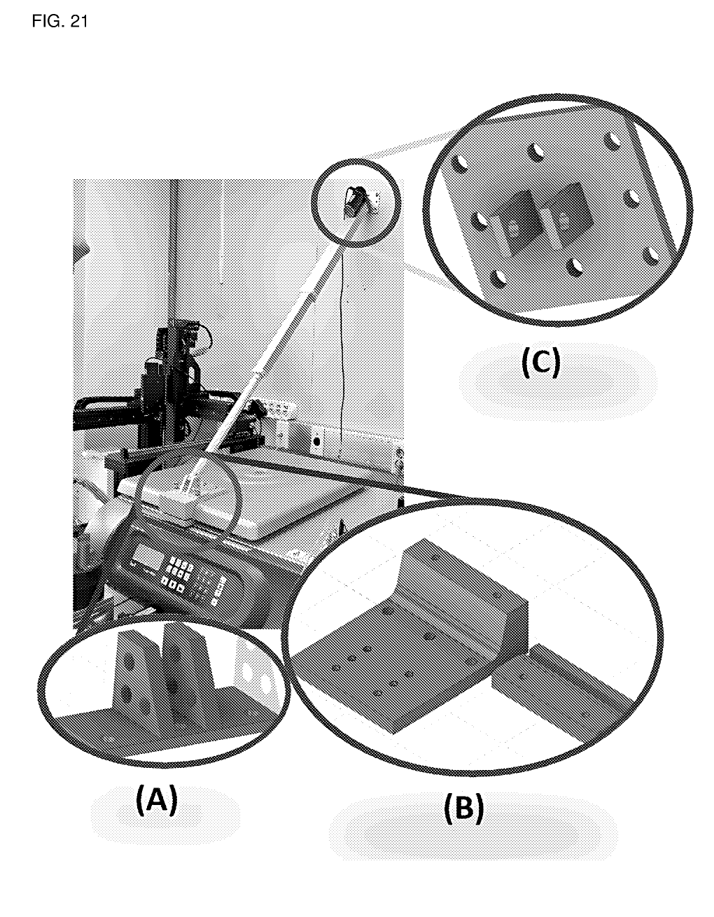

FIGS. 20 and 21 are views illustrating examples of the centrifuge 50 illustrated in FIG. 1. FIG. 20 illustrates a door opened by the actuator 51, and FIG. 21 illustrates a door closed by the actuator 51. Portion (A) of FIG. 21 has a fixing structure connected to a front end portion and a bracket of the actuator 51 and is designed to be adjustable according to an angle being connected. Portion (B) of FIG. 21 has a bracket structure that firmly fixes a door and is designed to be easily replaced according to a size and length of the actuator 51. Portion (C) of FIG. 21 illustrates a fixing structure for fixing the rear of the actuator 51 to a wall.

In operation 131, the centrifuge 50 inserts each of multiple centrifuge tubes into each of multiple holes of the rotor 52 based on a real-time image of the rotor 52 of the centrifuge under the control by the automatic control module 100. The automatic control module 100 detects a current position of each of the multiple holes of the rotor 52 based on a current position of a color sticker attached to a surface of the rotor 52 based on the real-time images of the rotor 52 of the centrifuge 50, and controls an operation of the centrifuge 50 such that each of the multiple centrifuge tubes is inserted into each of the multiple holes of the rotor 52 according to the current position of each of the multiple holes detected in this manner.

The surface of the rotor 52 of the centrifuge 50 has a form in which inlets of multiple holes are arranged radially from the center of a circle, and the color sticker is attached to a portion corresponding to a circular circumference of the surface of the rotor 52 between two adjacent inlets among the inlets of the multiple holes. In this way, when the color sticker is attached to the portion corresponding to the circular circumference of surface of the rotor 52 between two adjacent inlets, a position of the color sticker is easily identified by using computer vision, and as a result, positions of the inlets of the multiple holes in the surface of the rotor 52 may be accurately identified.

The centrifuge 50 detects a current position of the center of each of the inlets of the multiple holes in the surface of the rotor 52 based on the current position of the color sticker attached to the surface of the rotor 52 of the centrifuge 50 based on the real-time images of the rotor 52 of the centrifuge 50, and inserts multiple centrifuge tubes into the multiple holes in the surface of the rotor 52 through the inlets of the multiple holes in the surface of the rotor 52 based on the current position of the center of each of the inlets of the multiple holes detected in this way. Each time the centrifuge stops an operation, the position of each of the multiple holes in the surface of the rotor 52 changes, and due to this, it is difficult to distinguish between the multiple holes. The automatic control module 100 of the present embodiment may distinguish the multiple holes based on the color sticker attached to the surface of the rotor 52 of the centrifuge 50.

The automatic control module 100 may adjust the position of each centrifuge tube by using a priority algorithm before the centrifuge 50 starts centrifugation, and obtain the optimal rotation condition. The optimal rotation condition includes a rotation speed, rotation time, and rotation direction of the centrifuge 50 and is determined according to a type and sizes of nanoparticles to be separated. The priority algorithm analyzes the position information collected by the camera 60, and when there are multiple centrifuge tubes, the priority algorithm prioritizes the multiple centrifuge tubes based on the separation efficiency. Thereafter, the priority algorithm precisely adjusts the positions of the multiple centrifuge tube according to the calculated optimal rotation condition.

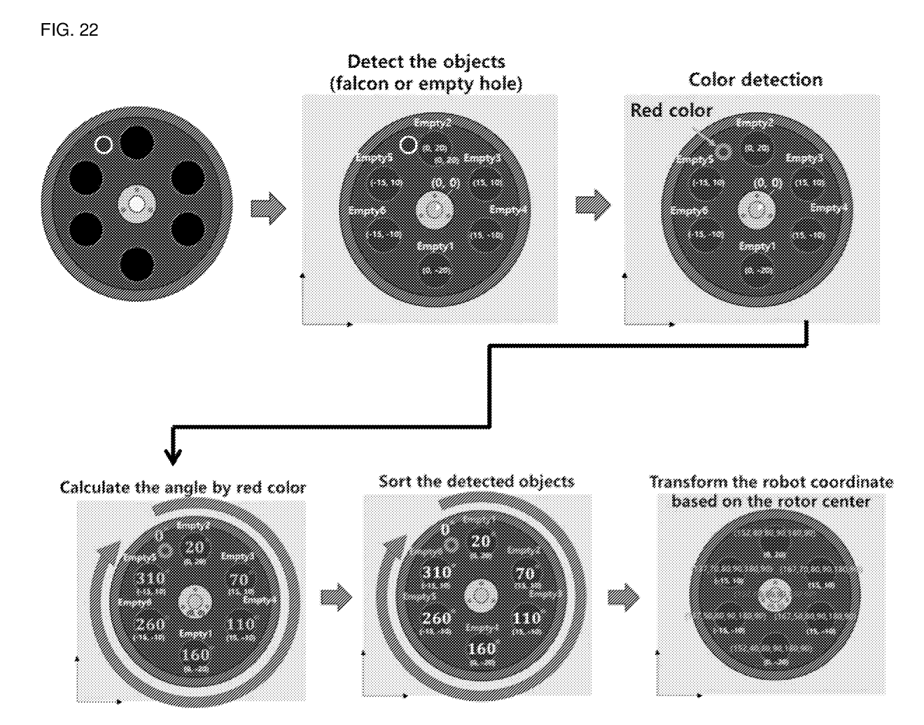

FIG. 22 is a view illustrating a process of determining pickup and arrangement of multiple centrifuge tubes in a centrifuge illustrated in FIG. 1. FIG. 22 illustrates a process of determining pickup and arrangement of the multiple centrifuge tubes in the centrifuge 50 according to the priority algorithm described above. First, positions and states of the multiple centrifuge tubes in the rotor 52 in the centrifuge 50 are detected. Thereafter, a red sticker attached to the centrifuge tube is detected to calculate an exact angle of the centrifuge tube.

For example, when the red sticker is attached to a position "Empty5", the automatic control module 100 calculates an angle of the red sticker. The calculation of the angle is performed based on the center of the rotor 52, and the automatic control module 100 determines where each centrifuge tube will be placed based on the position of the red sticker. When the calculation of the angle is completed, the automatic control module 100 sets a rotation angle of the rotor 52 to place each centrifuge tube in a specific slot. In this process, the rotor 52 adjusts the position of the centrifuge tube by rotating based on the calculated angle, and the position is then referenced when the robot arm 10 picks up and moves the centrifuge tube. Each slot in the rotor 52 determines an arrangement order of the centrifuge tubes based on specific coordinates. The coordinates are determined by the automatic control module 100.

For example, the coordinates of a slot "Empty1" are designated as (0, 20), a slot "Empty2" as (15, 21), and a slot "Empty3" as (15, -10). The coordinates are used as reference position information when the robot arm 10 moves to accurately place multiple centrifuge tubes in the rotor 52. When the calculation of the angle and the rotation of the rotor 52 are completed, the robot arm 10 moves the multiple centrifuge tubes to correct positions based on the calculated angle and coordinates under the control by the automatic control module 100. The robot arm 10 rotates the multiple centrifuge tubes by adjusting angles, and places the multiple centrifuge tubes in the correct positions based on the center of the rotor 52.

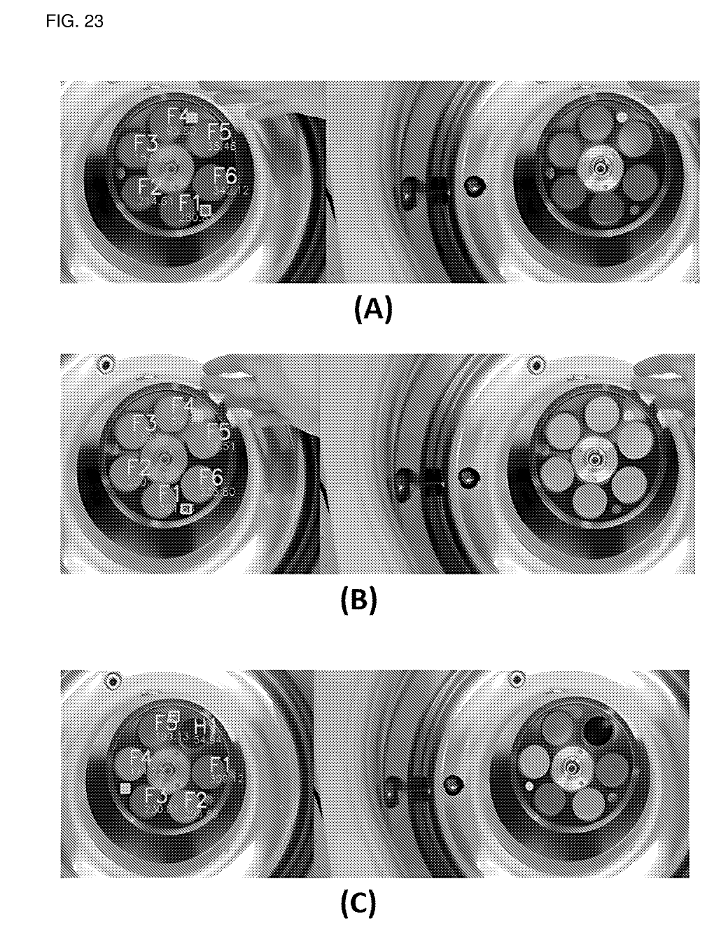

FIG. 23 is a view illustrating a process of detecting the pickup and a placement order of multiple centrifuge tubes based on a specific color sticker attached to the rotor 52 of the centrifuge tube. Images in (A), (B), and (C) of FIG. 23 illustrate a process of placing the multiple centrifuge tubes at specific positions in the rotor 52, and the exact positions and an order of the multiple centrifuge tubes are detected using a color recognition technology. The technology helps the multiple centrifuge tubes to be accurately placed in specific holes based on specific color stickers, and the automatic control module 100 determines the pickup and placement order of the multiple centrifuge tubes.

In operation 132, the centrifuge 50 operates the centrifuge 50 under the control by the automatic control module 100 in a state where the multiple centrifuge tubes are respectively inserted into multiple holes of the rotor 52, thereby centrifuging a nanoparticle solution to which a solvent is added for each of the multiple centrifuge tubes. In operation 133, when the centrifugation of the centrifuge 50 is completed in operation 132, the centrifuge 50 extracts the multiple centrifuge tubes respectively from the multiple holes of the rotor 52 based on the real-time images of the rotor 52 of the centrifuge under the control by the automatic control module 100.

After the multiple centrifuge tubes are extracted, it is necessary to prepare the multiple centrifuge tubes in a stably-aligned state before a solution removal operation is performed by the dispenser module 40 in operation 14. In order to perform the operation, an alignment holder 73 aligns the multiple centrifuge tubes for which the centrifugation operation is completed and places the multiple centrifuge tubes in correct positions before being placed in the centrifuge tube storage 72. The alignment holder 73 maintains the position of the centrifuge tubes so that the robot arm 10 may accurately pick up and place the centrifuge tubes, and stably adjusts the alignment state even during repeated operations.

In operation 14, the dispenser module 40 washes the nanoparticles contained in a nanoparticle solution for each of the multiple centrifuge tubes by removing the nanoparticle solution from the centrifugation result for each of the multiple centrifuge tubes in operation 13 under the control by the automatic control module 100. In this process, the robot arm 10 picks up the multiple centrifuge tubes from the centrifuge tube storage 72 and transfers the multiple centrifuge tubes to an operation position of the dispenser module 40. Thereafter, the dispenser actuator 41 of the dispenser module 40 is linked to a servo motor to move a tip to a boundary point inside the centrifuge tube, and the pump 42 connected to the tip sucks and remove a solution in the centrifuge tube. The automatic control module 100 controls operations of the dispenser actuator 41 and the pump 42 such that a solution removal operation is performed precisely, and detects a boundary between a solution and a sediment based on the real-time image data received from the camera 60.

In operation 141, the automatic control module 100 detects the boundary between the solution and the sediment contained in each of the multiple centrifuge tubes based on the real-time images of each of the multiple centrifuge tubes which are taken by the camera 60. Here, the sediment for each of the multiple centrifuge tubes is nanoparticles contained in a nanoparticle solution for each of the multiple centrifuge tubes. The automatic control module 100 may optimize a shooting angle of the camera 60 for each of the multiple centrifuge tubes by controlling an operation of the camera 60 using a viewpoint algorithm, and as a result, the automatic control module 100 may accurately analyze internal states of the multiple centrifuge tubes. The viewpoint algorithm provides optimal observation conditions by allowing the automatic control module 100 to adjust a position and rotation angle of the camera 60 using the robot arm 10.

In operation 141, the automatic control module 100 rotates the multiple centrifuge tubes until the boundary between the solution and sediment contained in each of the multiple centrifuge tubes is detected, and repeats a process of shooting the multiple centrifuge tubes in the rotated state. Each time a process of rotating the multiple centrifuge tubes is repeated, the multiple centrifuge tubes are rotated at different angles, and each time the multiple centrifuge tubes are rotated at different angles, a process of detecting the boundary between the solution and sediment contained in each of the multiple centrifuge tubes based on the real-time images of the multiple centrifuge tubes in the rotated state is repeated.

In operation 142, the dispenser module 40 removes a solution from the centrifuged results of the multiple centrifuge tubes based on the boundary between the solution and sediment detected for each centrifuge tube in operation 141 under the control by the automatic control module 100. The servo motor of the dispenser module 40 rotates the tip, and the dispenser actuator 41 moves the tip into the centrifuge tube and accurately places the tip at a position where a solution needs to be removed. The pump 42 connected to the tip sucks and removes the solution in the centrifuge tube.

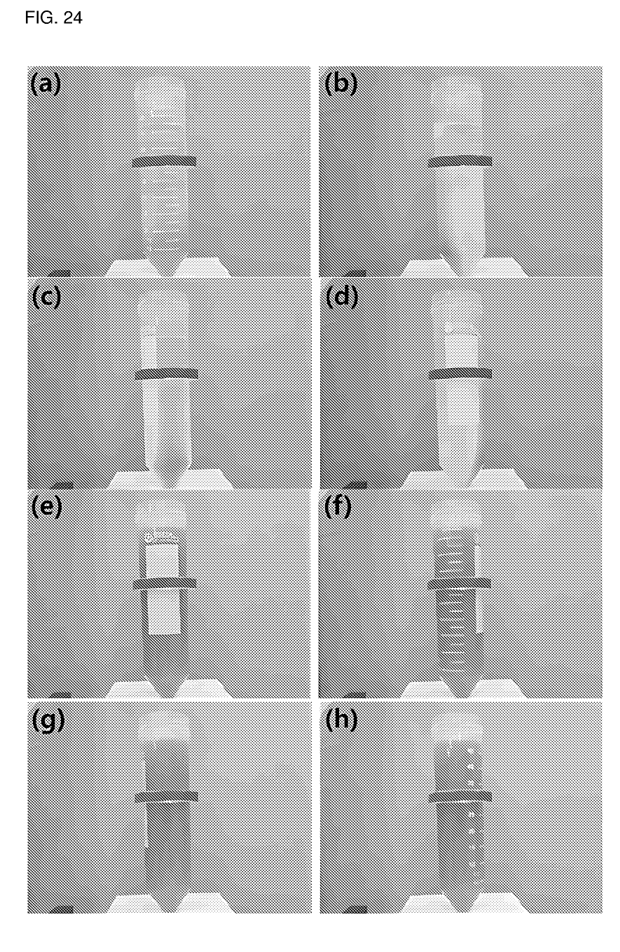

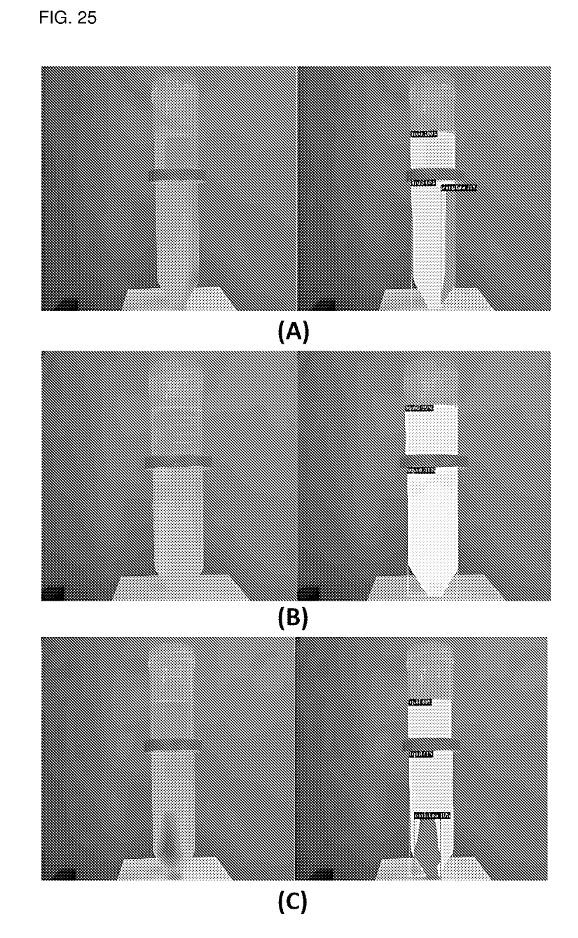

FIGS. 24 and 25 are views illustrating states of the sediment and solution in the centrifuge tube. (A) to (D) of FIG. 24 are images of a centrifuge tube taken at various angles of a sample with a sediment, and (E) to (H) of FIG. 24 are images of the centrifuge tube taken at various angles of the sample without sediment. (A) and (C) of FIG. 25 illustrate centrifuge tubes, each including a sediment, and (B) of FIG. 25 is a centrifuge tube without a sediment. The automatic control module 100 monitors a state of a solution and sediment in the centrifuge tube in real time using the camera 60 and controls an operation of the dispenser module 40 such that the dispenser module 40 starts a solution removal operation.

When the automatic control module 100 succeeds in detecting a boundary between the solution and the sediment for each centrifuge tube, the automatic control module 100 controls an operation of the dispenser module 40 such that the dispenser module 40 starts the solution removal operation. When the automatic control module 100 fails to detect the boundary between the solution and the sediment for a certain centrifuge tube, the automatic control module 100 controls an operation of the robot arm 10 such that the centrifuge tube is rotated by 60 degrees and attempts to detect again the boundary between the solution and the sediment based on images of the centrifuge tube in the rotated state. Rotation is performed by 60 degrees until the detection of the boundary between the solution and the sediment for the centrifuge tube is successful, and the detection may be repeated up to six times. When the detection of the boundary between the solution and the sediment for the centrifuge tube is successful, the automatic control module 100 controls an operation of the dispenser module 40 such that the solution removal operation for the centrifuge tube starts.

Nanoparticle solutions contained respectively in multiple vials are transferred respectively to multiple centrifuge tubes, a nanoparticle washing solvent is added to the nanoparticle solutions contained respectively in the multiple centrifuge tubes, and the nanoparticle solutions to which the nanoparticle washing solvent is added are centrifuged for each of the multiple centrifuge tubes based on the real-time images of a rotor of a centrifuge, and the nanoparticle solutions are removed from the centrifuged result for each of the multiple centrifuge tubes, and thus, nanoparticles contained in the nanoparticle solutions for each of the multiple centrifuge tubes are automatically washed. In this way, by automatically washing nanoparticles based on a computer vision technology, a problem of damaging a sediment layer and incompletely removing impurities caused by a manual operation of an operator may be solved.

In particular, an automatic control module controls an operation of a centrifuge such that a nanoparticle solution, to which a solvent is added, is centrifuged for each centrifuge tube based on real-time images of a rotor of the centrifuge, and thereby, the centrifuge tube, whose position may change each time within the centrifuge, may be placed correctly to ensure accurate centrifugation, and the automatic control module detects a boundary between a solution and a sediment contained in the centrifuge tube based on real-time images of the centrifuge tube to accurately distinguish a solution layer and a sediment layer, and as a result, impurities may be completely removed from the nanoparticles.

The effect described above are not limited, and other effects may be derived from the above description.

The present disclosure is mainly described on preferred embodiments. Those skilled in the art to which the present disclosure belongs will understand that the present disclosure may be implemented in a modified form without departing from the essential characteristics of the present disclosure. Therefore, the embodiments described above should be considered from an explanatory perspective, not a limited perspective. The scope of the present disclosure is indicated in the claims, not in the above description, and all differences within the scope equivalent thereto should be construed as being included in the present disclosure.

What is claimed is:

1. An automating nanoparticles washing method comprising:
transferring a nanoparticle solution contained in each of multiple vials from each of the multiple vials to each of multiple centrifuge tubes;
adding a nanoparticle washing solvent to the nanoparticle solution contained in each of the multiple centrifuge tubes for each of the multiple centrifuge tubes;
centrifuging the nanoparticle solution including the nanoparticle washing solvent for each of the multiple centrifuge tubes based on a real-time image of a rotor of a centrifuge; and
washing nanoparticles contained in the nanoparticle solution for each of the multiple centrifuge tubes by removing the nanoparticle solution from a centrifuged result for each of the multiple centrifuge tubes.

2. The automating nanoparticles washing method of claim 1, wherein the centrifuging of the nanoparticle solution including the nanoparticle washing solvent for each of the multiple centrifuge tubes includes:
inserting the multiple centrifuge tubes respectively into the multiple holes of the rotor based on a real-time image of the rotor of the centrifuge; and
centrifuging the nanoparticle solution including the solvent for each of the multiple centrifuge tubes by driving the centrifuge in a state where the multiple centrifuge tubes are respectively inserted into the multiple holes.

3. The automating nanoparticles washing method of claim 2, wherein
the centrifuging of the nanoparticle solution including the nanoparticle washing solvent for each of the multiple centrifuge tubes further includes extracting the multiple centrifuge tubes respectively from the multiple holes of the rotor based on the real-time image of the rotor of the centrifuge when centrifugation of the centrifuge is completed.

4. The automating nanoparticles washing method of claim 3, wherein,
in the inserting of the multiple centrifuge tubes, a current position of each of the multiple holes of the rotor is detected based on a current position of a color sticker attached to a surface of the rotor of the centrifuge based on the real-time image of the rotor of the centrifuge, and the multiple centrifuge tubes are respectively inserted into the multiple holes of the rotor based on the detected current position of each of the multiple holes.

5. The automating nanoparticles washing method of claim 4, wherein
the surface of the rotor has a form in which inlets of the multiple hole are arranged radially from a center of a circle, and
the color sticker is attached to a portion corresponding to a circular circumference of the surface of the rotor between two adjacent inlets among the inlets of the multiple holes.

6. The automating nanoparticles washing method of claim 4, wherein,
in the inserting of the multiple centrifuge tubes, a current position of each of centers of the inlets of the multiple holes in the surface of the rotor is detected based on the current position of the color sticker attached to the surface of the rotor of the centrifuge based on the real-time image of the rotor of the centrifuge, and the multiple centrifuge tubes are respectively inserted into the multiple holes in the surface of the rotor respectively through the inlets of the multiple holes in the surface of the rotor based on the detected current position of the center of each of the inlets of the multiple holes.

7. The automating nanoparticles washing method of claim 1,
wherein the washing of the nanoparticles contained in the nanoparticle solution for each of the multiple centrifuge tubes includes:
detecting a boundary between the nanoparticle solution and a sediment contained in each of the multiple centrifuge tubes based on the real-time image of each of the multiple centrifuge tubes; and
removing the nanoparticle solution from a centrifugation result for each of the multiple centrifugation tubes based on the boundary between the nanoparticle solution and the sediment detected for each of the multiple centrifugation tubes, and
the sediment for each of the multiple centrifugation tubes is nanoparticles contained in the nanoparticle solution for each of the multiple centrifugation tubes.

8. The automating nanoparticles washing method of claim 7, wherein,
in the detecting a boundary between the nanoparticle solution and a sediment contained in each of the multiple centrifuge tubes, a process of rotating the multiple centrifugation tubes until the boundary between the nanoparticle solution and the sediment contained in each of the multiple centrifugation tubes is detected and shooting the multiple centrifugation tubes in rotated states are repeated, and
each time the process of rotating the multiple centrifugation tubes is repeated, the multiple centrifugation tubes are rotated at different angles, and a process of detecting the boundary between the nanoparticle solution and the sediment contained in each of the multiple centrifugation tubes based on the real-time image of each of the multiple centrifugation tubes in the rotated states each time the multiple centrifugation tubes are rotated at different angles is repeated.

9. The automating nanoparticles washing method of claim 1, wherein the transferring of the nanoparticle solution to each of the multiple centrifuge tubes includes:
opening, by a robot arm, lids of the multiple centrifuge tubes;
transferring, by an electric pipetting module, the nanoparticle solution contained in each of the multiple vials from each of the multiple vials to each of the multiple centrifuge tubes; and
closing, by the robot arm, the lids of the multiple centrifuge tubes.

10. The automating nanoparticles washing method of claim 9, wherein the adding of the nanoparticle washing solvent includes:
opening, by the robot arm, the lids of the multiple centrifuge tubes;
adding, by the dispenser module, the nanoparticle washing solvent of a preset amount to the nanoparticle solution contained in each of the multiple centrifuge tubes; and
closing, by the robot arm, the lids of the multiple centrifuge tubes.

11. An automatic nanoparticle washing system comprising:
an electric pipetting module configured to transfer a nanoparticle solution contained in each of multiple vials from each of the multiple vials to each of multiple centrifuge tubes;
a dispenser module configured to add a nanoparticle washing solvent to the nanoparticle solution contained in each of the multiple centrifuge tubes for each of the multiple centrifuge tubes;
a centrifuge configured to centrifuge the nanoparticle solution to which the nanoparticle washing solvent is added for each of the multiple centrifuge tubes;
an automatic control module configured to control an operation of the centrifuge to centrifuge the nanoparticle solution to which the nanoparticle washing solvent is added for each of the multiple centrifuge tubes based on a real-time image of a rotor of the centrifuge,
wherein the dispenser module washes nanoparticles contained in the nanoparticle solution for each of the multiple centrifuge tubes by removing the nanoparticle solution from a centrifuged result for each of the multiple centrifuge tubes.
